(19) United States
(12) Patent Application Publication
(10) Pub. No.: US 2026/0003421 A1
(43) Pub. Date: Jan. 1, 2026

(54) ELECTRONIC DEVICE FOR PROVIDING MULTIPLE MODES, AND CONTROL METHOD THEREFOR

(71) Applicant: SAMSUNG ELECTRONICS CO., LTD., Suwon-si (KR)

(72) Inventors: Seungki CHO, Suwon-si (KR); Han KANG, Suwon-si (KR); Injae YU, Suwon-si (KR); Sunggyu LEE, Suwon-si (KR)

(73) Assignee: SAMSUNG ELECTRONICS CO., LTD., Suwon-si (KR)

(21) Appl. No.: 19/320,669

(22) Filed: Sep. 5, 2025

Related U.S. Application Data
(63) Continuation of application No. PCT/KR2024/000532, filed on Jan. 11, 2024.

(30) Foreign Application Priority Data
Mar. 8, 2023 (KR) 10-2023-0030636

(51) Int. Cl. G06F 3/00; G02F 1/133; G06V 40/16; G09G 3/36

(52) U.S. Cl. CPC G06F 3/005; G02F 1/13312; G06V 40/166; G09G 3/3611; G09G 2320/0613; G09G 2354/00; G09G 2360/144

(57) ABSTRACT

An electronic device comprising a switchable mirror operating in a transparent mode or a mirror mode; a display to be arranged such that at least a portion of the display faces one surface of the switchable mirror; and at least one processor while connected to the switchable mirror and the display obtains information about the operating mode of the electronic device, and controls, based on the obtained information, the operating mode of the electronic device to be in in any one of a first mode in which the switchable mirror is in the transparent mode and the display is turned on, a second mode in which the switchable mirror is in the mirror mode and the display is turned on, and a third mode in which the switchable mirror is in the mirror mode and the display is turned off.

### CROSS-REFERENCE TO RELATED APPLICATION

This application is a continuation application is a continuation application, under 35 U.S.C. § 111(a), of international application No. PCT/KR2024/000532, filed Jan. 11, 2024, which claims priority under 35 U. S. C. § 119 to Korean Patent Application No. 10-2023-0030636, filed Mar. 8, 2023, the disclosures of which are incorporated herein by reference in their entireties.

### TECHNICAL FIELD

Apparatuses and methods consistent with the present disclosure relate to an electronic device and a control method therefor, and more particularly, to an electronic device for providing multiple modes and a control method therefor.

### BACKGROUND ART

With the development of electronic technology, various types of electronic devices are being developed. In particular, products for improving user convenience and providing users with diverse user experiences have been developed recently.

For example, a smart mirror display is a device that may control transmittance and reflectance for a specific region to use the specific region as a high-definition display as needed, thereby improving user convenience. A smart mirror display may be referred to as a smart mirror, a mirror display, a switching mirror display, a switchable mirror display, a mirror TV, etc.

However, most mirror displays do not use a switchable mirror element, but provide a mirror and an image at the same time by attaching a transparent film, glass, acrylic material, etc., on the display. However, since it is necessary to simultaneously satisfy the reflection property for optimizing the mirror function and the transmission property for optimizing image quality, there is an issue where neither property can be fully perfected.

Alternatively, in the case of a mirror display using a switchable mirror element, the above problems have been solved, but there is a lack of research on what kind of interaction to provide to users.

### DISCLOSURE OF INVENTION

### Solution to Problem

In accordance with an aspect of the disclosure, an electronic device includes: a switchable mirror configured to operate in a transparent mode or in a mirror mode; a display arranged so that at least a portion is directed to one surface of the switchable mirror; and at least one processor configured to be connected to the switchable mirror and the display, and while the at least one processor is connected to the switchable mirror and the display, the at least one processor is configured to obtain information about an operating mode of the electronic device, and control, based on the obtained information, the operating mode of the electronic device to be in any one of a first mode in which the switchable mirror is in the transparent mode and the display is turned on, a second mode in which the switchable mirror is in the mirror mode and the display is turned on, and a third mode in which the switchable mirror is in the mirror mode and the display is turned off.

The electronic device may further include a sensor, in which the at least one processor may be configured to change the operating mode of the electronic device to one of the first mode and the second mode based on a user being identified through the sensor.

The electronic device may further include a sensor, in which the at least one processor may be configured to obtain detection data for external light around the electronic device through the sensor, and change the operating mode of the electronic device to one of the first mode, the second mode, and the third mode based on the detection data.

The electronic device may further include a communication interface, in which the at least one processor may be configured to receive content through the communication interface, and change the operating mode of the electronic device to one of the first mode and the second mode based on a type of the content.

The electronic device may further include a user interface, in which the at least one processor may be configured to change the operating mode of the electronic device to one of the first mode, the second mode, and the third mode based on a user command is received from a user through the user interface.

The at least one processor may be configured to identify the switchable mirror as being divided into a plurality of regions, and control the switchable mirror to respectively operate the plurality of first regions in one of the first mode, the second mode, and the third mode.

The plurality of regions may be a plurality of first regions and the at least one processor may be configured to identify the display as having a plurality of second regions corresponding to the plurality of first regions, and control the display to turn on a second region among the plurality of second regions corresponding to a first region among the plurality of first regions of the switchable mirror operating in the first mode or the second mode.

The electronic device may further include a camera, in which the at least one processor may be configured to obtain a captured image of a user in front of the electronic device through the camera, identify the user from the captured image, and control the switchable mirror to operate in one region based on the user being a first user, and to operate the switchable mirror in the plurality of regions based on the user being identified a second user.

The switchable mirror may operate in the transparent mode based on a voltage being applied, and operates in the mirror mode based on the voltage being not applied, the transparent mode may be a mode in which a transmittance of the switchable mirror is equal to or greater than a preset first transmittance and a reflectance of the switchable mirror is less than a preset first reflectance, and the mirror mode may be a mode in which the transmittance is less than a preset second transmittance and the reflectance is equal to or greater than a preset second reflectance.

The electronic device may further include a mirror arranged on that is same plane as the switchable mirror, in which the switchable mirror may have a reflectance less than a preset difference from the reflectance of the mirror while the switchable mirror is in the mirror mode.

The electronic device may further include a gap filler arranged between the switchable mirror and the mirror.

The switchable mirror may operate in one of a plurality of sub-mirror modes or the transparent mode, the at least one processor may be configured to control the switchable mirror to operate in one of the plurality of sub-mirror modes or the transparent mode based on at least one of detection data for external light around the electronic device or the type of content to be displayed through the display, and the plurality of sub-mirror modes may have different transmittance and reflectance from each other.

In accordance with another aspect of the disclosure, a control method of an electronic device includes: obtaining information about an operating mode of the electronic device; and controlling, based on the obtained information, the operating mode of the electronic device to be in any one of a first mode in which a switchable mirror is in a transparent mode and a display arranged so that a portion is directed to one surface of the switchable mirror is turned on, a second mode in which the switchable mirror is in a mirror mode and the display is turned on, and a third mode in which the switchable mirror is in the mirror mode and the display is turned off.

The control method may further include identifying a user through a sensor of the electronic device, in which, in the controlling, the operating mode of the electronic device may change to one of the first mode and the second mode based on the user.

The control method may further include obtaining detection data for external light around the electronic device through a sensor of the electronic device, in which in the controlling, the operating mode of the electronic device may change to one of the first mode, the second mode, and the third mode based on the detection data.

The control method may further include receiving content, in which, in the controlling, the operating mode of the electronic device may change to one of the first mode and the second mode based on the type of the content.

The control method may further include receiving a user command from a user, in which, in the controlling, the operating mode of the electronic device may change to one of the first mode, the second mode, and the third mode based on the user command.

The control method may further include identifying the switchable mirror by dividing the switchable mirror into a plurality of first regions, in which, in the controlling, the switchable mirror may be controlled to operate each of the plurality of first regions in one of the first mode, the second mode, and the third mode.

The control method may further include identifying the display in the plurality of second regions corresponding to each of the plurality of first regions, in which, in the controlling, the display may be controlled to turn on the second region corresponding to a region operating in the first mode or the second mode among the plurality of first regions.

In addition, the control method may further include obtaining the captured image of the user in front of the electronic device through the camera of the electronic device and identifying the user from the captured image, in which, in the controlling, the switchable mirror may operate in one region when the user is the first user, and the switchable mirror may operate in the plurality of first regions when the user is the second user.

In addition, the switchable mirror may operate in the transparent mode when the voltage is applied, and in the mirror mode when the voltage is not applied, and the transparent mode may be a mode in which the transmittance of the switchable mirror is equal to or greater than the first preset transmittance and the reflectance of the switchable mirror is less than the first preset reflectance, and the mirror mode may be a mode in which the transmittance is less than the second preset transmittance and the reflectance is equal to or greater than the second preset reflectance.

### BRIEF DESCRIPTION OF DRAWINGS

FIG. 1 is a block diagram illustrating a configuration of an electronic device according to an embodiment of the present disclosure.

FIG. 2 is a block diagram illustrating a detailed configuration of the electronic device according to an embodiment of the present disclosure.

FIG. 3 is a diagram for describing a switching region of the electronic device according to an embodiment of the present disclosure.

FIGS. 4 and 5 are diagrams for describing a structure of the electronic device according to an embodiment of the present disclosure.

FIGS. 6 to 8 are diagrams for describing various implementation forms of the electronic device according to an embodiment of the present disclosure.

FIG. 9 is a diagram for describing an operation by user interaction according to an embodiment of the present disclosure.

FIG. 10 is a diagram for describing the operation by the user interaction according to an embodiment of the present disclosure.

FIGS. 11 and 12 are diagrams for describing specific implementation examples of the switching region according to an embodiment of the present disclosure.

FIGS. 13 and 14 are diagrams for describing a method of connecting a switchable mirror and a mirror according to an embodiment of the present disclosure.

FIG. 15 is a flowchart for describing a control method of an electronic device according to an embodiment of the present disclosure.

### MODE FOR INVENTION

An object of the present disclosure is to provide an electronic device that provides a user with multiple usage modes, and a control method therefor.

Hereinafter, the present disclosure will be described in detail with reference to the accompanying drawings.

General terms that are currently widely used were selected as terms used in embodiments of the disclosure in consideration of functions in the disclosure, but may be changed according to the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in embodiments of the disclosure are to be defined on the basis of the meaning of the terms and the contents throughout the disclosure rather than simple names of the terms.

In the specification, an expression “have”, “may have”, “include”, “may include”, or the like, indicates existence of a corresponding feature (e.g., a numerical value, a function, an operation, a component such as a part, or the like), and does not exclude existence of an additional feature.

An expression “at least one of A and/or B” is to be understood to represent “A” or “B” or “any one of A and B”.

Expressions “first,” “second,” “1^{st}” or “2^{nd}” or the like, used in the present disclosure may indicate various components regardless of a sequence and/or importance of the components, will be used only in order to distinguish one component from the other components, and do not limit the corresponding components.

Singular forms include plural forms unless the context clearly indicates otherwise. It should be understood that terms “include” or “formed of” used in the specification specify the presence of features, numerals, steps, operations, components, parts, or combinations thereof mentioned in the specification, but do not preclude the presence or addition of one or more other features, numerals, steps, operations, components, parts, or combinations thereof.

In the disclosure, the term user may refer to a person using an electronic device or a device (for example, an artificial intelligence electronic device) using the electronic device.

Hereinafter, diverse embodiments of the disclosure will be described in more detail with reference to the accompanying drawings.

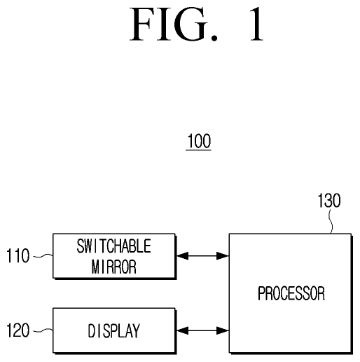

FIG. 1 is a block diagram illustrating a configuration of an electronic device 100 according to an embodiment of the present disclosure.

The electronic device 100 may be a device that operates as a mirror or a screen that provides information. For example, the electronic device 100 may be a mirror formed on a wall, and may be a device that operates as a mirror or increases a transmittance of the mirror and increases a reflectance to provide information through a display formed on a rear surface of the mirror.

However, the present disclosure is not limited thereto, and the electronic device 100 may be any device that operates as the mirror or the screen that provides the information. For example, the electronic device 100 may be implemented in a form in which the mirror capable of changing the transmittance and reflectance is attached to a device equipped with a display, such as a TV. For example, when the mirror is attached to a display of a TV, the TV may provide content or operate as the mirror.

Referring to FIG. 1, the electronic device 100 includes a switchable mirror 110, a display 120, and a processor 130.

The switchable mirror 110 may be a device that operates in a transparent mode or a mirror mode. For example, the switchable mirror 110 may operate in a transparent mode when a voltage is applied, and operate in a mirror mode when the voltage is not applied. For example, the switchable mirror 110 may be implemented with a material that controls liquid crystals electrically to adjust the transmittance/reflectance. The switchable mirror 110 may adjust the transmittance/reflectance differently for each region under the control of the processor 130. Here, the transparent mode may be a mode in which the transmittance of the switchable mirror 110 is equal to or greater than a first preset transmittance and the reflectance of the switchable mirror 110 is less than a first preset reflectance, and the mirror mode may be a mode in which the transmittance is less than a second preset transmittance and the reflectance is equal to or greater than a second preset reflectance.

However, the present disclosure is not limited thereto, and the switchable mirror 110 may be implemented in various forms as long as it may operate in the transparent mode or the mirror mode. For example, the switchable mirror 110 may be implemented in a form in which transparency gradually changes based on the strength of the applied voltage.

The switchable mirror 110 may be made of glass or acrylic. For example, the switchable mirror 110 may be a two-way mirror made of glass that has a bronze tone having a reflectance of 70% and a transmittance of 11%. Alternatively, the switchable mirror 110 may be a two-way mirror made of acrylic that has a silver tone having a reflectance of 70% and a transmittance of 30%. Alternatively, the switchable mirror 110 may be a smart mirror made of glass that has a natural color with a reflectance of 70% and a transmittance of 30%. Alternatively, the switchable mirror 110 may be a natural color with a reflectance of 30% and a transmittance of 70% and may be a dielectric mirror made of acrylic. However, the present disclosure is not limited thereto, and the switchable mirror 110 may be made of various materials.

The display 120 is a component that provides information, and may be implemented as various types of displays such as a liquid crystal display (LCD), an organic light emitting diode (OLED) display, a plasma display panel (PDP), and the like. A driving circuit, a backlight unit, and the like, that may be implemented in the form such as an a-si thin film transistor (TFT), a low temperature poly silicon (LTPS), a TFT, an organic TFT (OTFT), and the like, may be included in the display 120. Meanwhile, the display 120 may be implemented as a touch screen combined with a touch sensor, a flexible display, a three-dimensional (3D) display, or the like.

The display 120 may be arranged so that a portion providing information may be directed to one surface of the switchable mirror 110. That is, a user may view the information provided by the display 120 through the switchable mirror 110 operating in a transparent mode.

The processor 130 generally controls the operation of the electronic device 100. Specifically, the processor 130 may be connected to each component of the electronic device 100 to generally control an operation of the electronic device 100. For example, the processor 130 may be connected to components such as the switchable mirror 110, the display 120, a sensor (not illustrated), and a communication interface (not illustrated), and may control the operation of the electronic device 100.

At least one processor may include one or more of a central processing unit (CPU), a graphics processing unit (GPU), an accelerated processing unit (APU), a many integrated core (MIC), a neural processing unit (NPU), a hardware accelerator, or a machine learning accelerator. At least one processor may control one or any combination of other components of the electronic device 100 and perform operations related to communication or data processing. At least one processor may execute one or more programs or instructions stored in memory. For example, at least one processor may perform the method according to an embodiment of the present disclosure by executing one or more instructions stored in the memory.

When the method according to an embodiment of the present disclosure includes a plurality of operations, the plurality of operations may be performed by one processor or by a plurality of processors. For example, when a first operation, a second operation, and a third operation are performed by the method according to an embodiment, the first operation, the second operation, and the third operation may all be performed by a first processor, the first operation and the second operation may be performed by the first processor (e.g., a general-purpose processor), and the third operation may be performed by a second processor (e.g., an artificial intelligence-specific processor).

At least one processor may be implemented as a single core processor including one core, or one or more multicore processors including a plurality of cores (e.g., homogeneous multicore or heterogeneous multicore). When at least one processor is implemented as a multicore processor, each of the plurality of cores included in the multicore processor may include an internal memory of the processor such as a cache memory and an on-chip memory, and a common cache shared by a plurality of cores may be included in a multicore processor. In addition, each of the plurality of cores (or some of the plurality of cores) included in the multi-core processor may read and perform program instructions for implementing the method according to an embodiment of the present disclosure, and all (or part) of the plurality of cores may be linked to read and perform program instructions for implementing the method according to an embodiment of the present disclosure.

When the method according to an embodiment of the present disclosure includes a plurality of operations, the plurality of operations may be performed by one of a plurality of cores included in a multicore processor, or may be performed by the plurality of cores. For example, when the first operation, the second operation, and the third operation are performed by the method according to an embodiment, the first operation, the second operation, and the third operation may all be performed by the first processor in the multicore processor, the first operation and the second operation may be performed by a first core included in the multicore processor, and the third operation may be performed by a second core included in the multicore processor.

In an embodiment of the present disclosure, the processor may be a system-on-chip (SoC) in which at least one processor and other electronic components are integrated, a single-core processor, a multi-core processor, or a core included in the single-core processor or the multi-core processor. Here, the core may be implemented as CPU, GPU, APU, MIC, NPU, a hardware accelerator, a machine learning accelerator, or the like, but embodiments of the present disclosure are not limited thereto. However, for the convenience of description, the operation of the electronic device 100 will be described below using the expression processor 130.

The processor 130 may obtain information about the operating mode of the electronic device 100, and control, based on the obtained information, the switchable mirror 110 and the display 120 to operate in one of a first mode (display mode) in which the switchable mirror 110 is in a transparent mode and the display 120 is turned on, a second mode (hybrid mode) in which the switchable mirror 110 is in a mirror mode and the display 120 is turned on, and a third mode in which the switchable mirror 110 is in the mirror mode and the display 120 is turned off. Here, the first mode is a case in which the electronic device 100 is used as a display device, and a user may obtain information through the display 120 of the electronic device 100. The second mode is a state in which the display 120 is turned on but the switchable mirror 110 also operates in the mirror mode, and the user may have difficulty watching a video or reading text due to mirror characteristics. However, in the case of the second mode, a new display feeling may be provided to a user through an ambient screen that stimulates emotions, a background screen displayed in sync with music, etc. The third mode may be a case where the electronic device 100 is used as a mirror. Meanwhile, the information about the operating mode of the electronic device 100 may include information about at least one element that determines the operating mode of the electronic device 100. For example, the information about the operating mode of the electronic device 100 may include information about presence of a user, external light around the electronic device 100, a type of content, a user command, etc., which will be described later. For example, the processor 130 may change the operating mode of the electronic device 100 to one of the first mode and the second mode when the brightness of the environment around the electronic device 100 is equal to or higher than a preset brightness, and change the operating mode of the electronic device 100 to the third mode when the brightness of the environment around the electronic device 100 is less than the preset brightness. Alternatively, the processor 130 may change the operating mode of the electronic device 100 to one of the first mode and the second mode when the content is sports, movies, etc., and change the operating mode of the electronic device 100 to the third mode when the content is an image. That is, the operating mode of the electronic device 100 may be determined based on at least one of the presence of the user, the external light around the electronic device 100, the type of content, or the user command. The electronic device 100 may further include a sensor, and when the user is identified through the sensor, the processor 130 may change the operating mode of the electronic device 100 to one of the first mode and the second mode based on the user. For example, the processor 130 may operate in the third mode while the user is not identified, and change the third mode to one of the first mode and the second mode when the user is identified through the sensor. That is, the electronic device 100 may operate as the mirror, and when the user approaches, provide the user with information such as weather, temperature, and traffic conditions. However, the present disclosure is not limited thereto, and the processor 130 may operate in one of the first and second modes while the user is not identified, and change the operating mode to the third mode when the user is identified through the sensor. For example, the electronic device 100 may operate to display a work of art and appear like a picture frame, and then change the operating mode to the third mode when the user approaches and operate as a mirror so that the user may check his or her appearance. The processor 130 may change the operating mode after the user is identified, and restore the operating mode when the user is not identified again. For example, the processor 130 may operate in the third mode while the user is not identified, and change the third mode to one of the first and second modes when the user is identified through the sensor, and restore the operating mode to the third mode when the user is not identified again.

The electronic device 100 further includes the sensor, and the processor 130 may obtain detection data for external light around the electronic device 100 through the sensor, and may change, based on the detection data, the operating mode of the electronic device 100 to one of the first mode, the second mode, and the third mode.

For example, the processor 130 may obtain the detection data for the external light around the electronic device 100 through the sensor, and change, based on the detection data, the operating mode to the third mode when the brightness of the external light is higher than the preset brightness, and change the operating mode to one of the first mode and the second mode when the brightness of the external light is lower than the preset brightness. This is because, in the case of darkness, the electronic device 100 may not function as the mirror even if it operates as a mirror.

The electronic device 100 further includes a communication interface, and the processor 130 may receive content through the communication interface, and change, based on the type of content, the operating mode of the electronic device 100 to one of the first mode and the second mode.

For example, the processor 130 may receive content from the user terminal device. When the content includes a video or text, the processor 130 may change the operating mode to the first mode, and when the content is an image such as a work of art, the processor 130 may change the operating mode to the second mode.

The electronic device 100 further includes a user interface, and when a user command is received from the user through the user interface, the processor 130 may change the operating mode of the electronic device 100 to one of the first mode, the second mode, and the third mode based on the user command.

However, the present disclosure is not limited thereto, and the electronic device 100 may also receive the user command through the communication interface, a microphone, a camera, etc.

The processor 130 may identify the switchable mirror 110 by dividing the switchable mirror 110 into a plurality of first regions, and control the switchable mirror 110 to operate each of the plurality of first regions in one of the first mode, the second mode, and the third mode. The processor 130 may control the display 120 to identify the display 120 in a plurality of second regions corresponding to each of the plurality of first regions, and to turn on the second region corresponding to a region operating in the first mode or the second mode among the plurality of first regions.

For example, the processor 130 may control the switchable mirror 110 to identify the switchable mirror 110 in three regions, control the switchable mirror 110 to operate a first region 1 in the first mode, a first region 2 in the second mode, and a third region 3 in the third mode among the three regions, and identify the display 120 in the plurality of second regions corresponding to each of the three first regions and to turn on a second region 1 and a second region 2 corresponding to the first region 1 and the first region 2, respectively.

Here, the electronic device 100 further includes the camera, and the processor 130 may identify a user's face position through the camera, and change the region of the first mode 3 based on the user's face position. For example, when the user's face is closer to the first region 1 than the first region 3, the processor 130 may change the first region 1 to the third mode and change the first region 3 to the first mode. In this case, the processor 130 may control the display 120 to turn off the second region 1 and turn on the second region 3 corresponding to the first region 3.

The processor 130 may obtain a captured image of a user in front of the electronic device 100 through the camera, identify the user from the captured image, and control the switchable mirror 110 to operate the switchable mirror 110 in one region when the user is a first user, and to operate the switchable mirror 120 as a plurality of first regions when the user is a second user.

Alternatively, the processor 130 may determine whether to divide the switchable mirror 110 into the plurality of regions based on the number of users in front of the electronic device 100. For example, the processor 130 may control the switchable mirror 110 to operate the switchable mirror 110 in one region when there is one user in front of the electronic device 100, and to operate the switchable mirror 120 in the plurality of first regions when there are multiple users in front of the electronic device 100.

The electronic device 100 further includes the mirror arranged on the same plane as the switchable mirror 110, and the switchable mirror 110 may have a reflectance less than a preset difference from the reflectance of the mirror when the switchable mirror 110 is in the mirror mode. That is, when the electronic device 100 operates in the third mode, the switchable mirror 110 and the mirror may appear as one large mirror.

Here, the electronic device 100 may further include a gap filler arranged between the switchable mirror 110 and the mirror. However, the present disclosure is not limited thereto, and the electronic device 100 may be implemented in a form in which an air gap is formed between the switchable mirror 110 and the mirror.

Meanwhile, the switchable mirror 110 may operate in one of a plurality of sub-mirror modes or in the transparent mode. Here, the plurality of sub-mirror modes may have different transmittance and reflectance. For example, the switchable mirror 110 may operate in one of the first sub-mirror mode and the second sub-mirror mode or in the transparent mode. Here, the first sub-mirror mode may have a transmittance of 60%, the second sub-mirror mode may have a transmittance of 40%, and the transparent mode may have a transmittance of 80%. However, the present disclosure is not limited thereto, and the number of sub-mirror modes may vary, and the transmittance of each sub-mirror mode may also be implemented in various ways.

The processor 130 may control the switchable mirror 110 to operate in one of the plurality of sub-mirror modes or in the transparent mode based on at least one of the detection data for the external light around the electronic device 100 or the type of content to be displayed through the display 120.

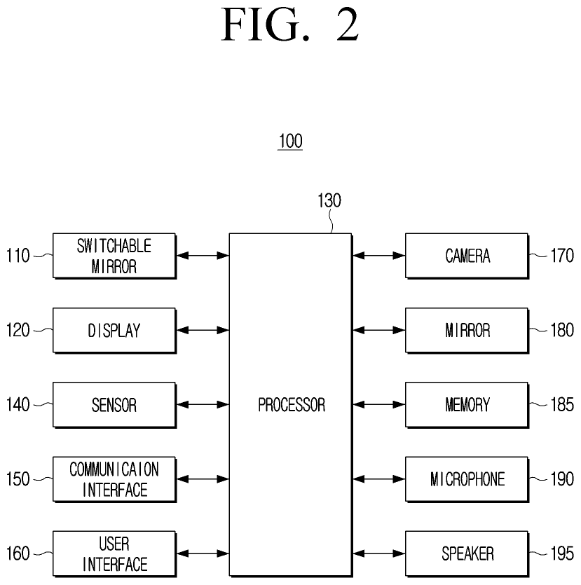

FIG. 2 is a block diagram illustrating a detailed configuration of the electronic device 100 according to an embodiment of the present disclosure. The electronic device 100 may include a switchable mirror 110, a display 120, and a processor 130. In addition, referring to FIG. 2, the electronic device 100 may further include a sensor 140, a communication interface 150, a user interface 160, a camera 170, a mirror 180, a memory 185, a microphone 190, and a speaker 195. Detailed description of components illustrated in FIG. 2 that overlap with components illustrated in FIG. 1 will be omitted.

The sensor 140 may include an RGB-D sensor, a ToF sensor, and the like. The processor 130 may obtain an RGB image in a visible light region, a depth image via IR, and a thermal image via IR through the RGB-D sensor. The ToF sensor may be a sensor that calculates a distance for light emitted from an object through an infrared wavelength to bounce back and recognizes three-dimensionality, spatial information, and movement of an object. The processor 130 may identify a user based on data acquired from the sensor 140.

The sensor 140 may further include an illuminance sensor. The illuminance sensor may be a sensor that detects illuminance, which indicates the amount of light received per unit area per unit time.

The communication interface 150 is a component performing communication with various types of external devices depending on various types of communication manners. For example, the electronic device 100 may perform communication with the user terminal device or the server through the communication interface 150.

The communication interface 150 may include a wireless fidelity (WiFi) module, a Bluetooth module, an infrared communication module, a wireless communication module, and the like. Here, each communication module may be implemented in the form of at least one hardware chip.

The Wi-Fi module and the Bluetooth module perform communication in a Wi-Fi manner and a Bluetooth manner, respectively. When the Wi-Fi module or the Bluetooth module is used, various connection information such as a service set identifier (SSID), a session key, and the like, is first transmitted and received, communication is connected using the connection information, and various information may then be transmitted and received. The infrared communication module performs communication according to an infrared data association (IrDA) technology of wirelessly transmitting data to a short distance using an infrared ray positioned between light and a millimeter wave.

The wireless communication module may include at least one communication chip performing communication according to various wireless communication standards such as zigbee, 3^{rd} generation (3G), 3^{rd} generation partnership project (3GPP), long term evolution (LTE), LTE advanced (LTE-A), 4^{th} generation (4G), 5^{th} generation (5G), and the like, in addition to the communication manner described above.

Alternatively, the communication interface 150 may include a wired communication interface such as HDMI, DP, Thunderbolt, USB, RGB, D-SUB, and DVI.

In addition, the communication interface 150 may include a local area network (LAN) module, an Ethernet module, and at least one of wired communication modules performing communication using a pair cable, a coaxial cable, an optical fiber cable, etc.

The user interface 160 may be implemented as a button, a touch pad, a mouse, a keyboard, etc., or may be implemented as a touch screen that may perform both of the display function and manipulation input function. Here, the button may be various types of buttons such as a mechanical button, a touch pad, a wheel, and the like, formed in any region such as a front surface portion, a side surface portion, a back surface portion, and the like, of a body appearance of the electronic device 100.

The camera 170 is a component for capturing a still image or a moving image. The camera 170 may capture a still image at a specific point in time, but may also continuously capture a still image.

The camera 170 may capture one direction of the electronic device 100. In particular, the processor 130 may identify the user's location, the number of people, etc., based on the image captured by the camera 170.

The camera 170 may include a lens, a shutter, an aperture, a solid state imaging device, an analog front end (AFE), and a timing generator (TG). The shutter controls the time for light reflected from the subject to enter the camera 170, and the aperture mechanically increases or decreases the size of the opening through which light enters to control the amount of light incident on the lens. When the solid state imaging device accumulates the light reflected from the subject as photocharges, it outputs an image by the photocharges as an electrical signal. The TG outputs a timing signal for reading out pixel data of the solid state imaging device, and the AFE samples and digitizes the electrical signal output from the solid state imaging device.

The mirror 180 is arranged on the same plane as the switchable mirror 110, and is an optical tool used to project an image of an object by utilizing light reflection from a metal surface.

The memory 185 may refer to hardware storing information such as data in an electric or magnetic form so that the processor 130, etc., may access the memory 120. To this end, the memory 185 may be implemented as at least one hardware of a non-volatile memory, a volatile memory, a flash memory, a hard disk drive (HDD), a solid state drive (SDD), a RAM, a ROM, or the like.

At least one instruction required for an operation of the electronic device 100 or the processor 130 may be stored in the memory 185. Here, the instruction is a code unit for instructing the operation of the electronic device 100 or the processor 130, and may be written in a machine language, which is a language that a computer may understand. Alternatively, a plurality of instructions that perform a specific task of the electronic device 100 or the processor 130 may be stored in the memory 185 as an instruction set.

The memory 185 may store data that is information in units of bits or bytes capable of representing characters, numbers, images, and the like. For example, the information about the operating mode, etc., may be stored in the memory 185.

The memory 185 is accessed by the processor 130, and the instruction, the instruction set, or data may be read/written/modified/deleted/updated or the like by the processor 130.

The microphone 190 is a component for receiving sound and converting the sound into an audio signal which is an electrical signal. The microphone 190 is electrically connected to the processor 130 and may receive sound under the control of the processor 130.

For example, the microphone 190 may be formed on an upper side, a front surface, a side surface, etc., of the electronic device 100. Alternatively, the microphone 190 may be provided between the switchable mirror 110 and the mirror 180. Alternatively, the microphone 190 may be provided in a device separate from the electronic device 100, such as a remote control. In this case, the remote control, which is a separate device, may receive sound through the microphone 190 and provide an audio signal, which is an electrical signal corresponding to the received sound, to the electronic device 100.

The microphone 190 may include various components such as a microphone collecting sound having an analog form, an amplifier circuit amplifying the collected sound, an A/D converting circuit sampling the amplified sound to convert the amplified sound into a digital signal, a filter circuit removing a noise component from the converted digital signal, and the like.

Meanwhile, the microphone 190 may be implemented in the form of a sound sensor, and any configuration that may collect sound can be used.

The speaker 195 is a component outputting various notification sounds, an audio message, or the like, as well as various audio data processed by the processor 130.

As described above, the electronic device 100 may operate in multiple modes, thereby providing various interactions and aesthetic satisfaction to the user. In addition, the electronic device 100 may divide the switchable mirror 110 and the display 120 into the plurality of regions and operate the plurality of regions in individual modes, thereby improving user convenience.

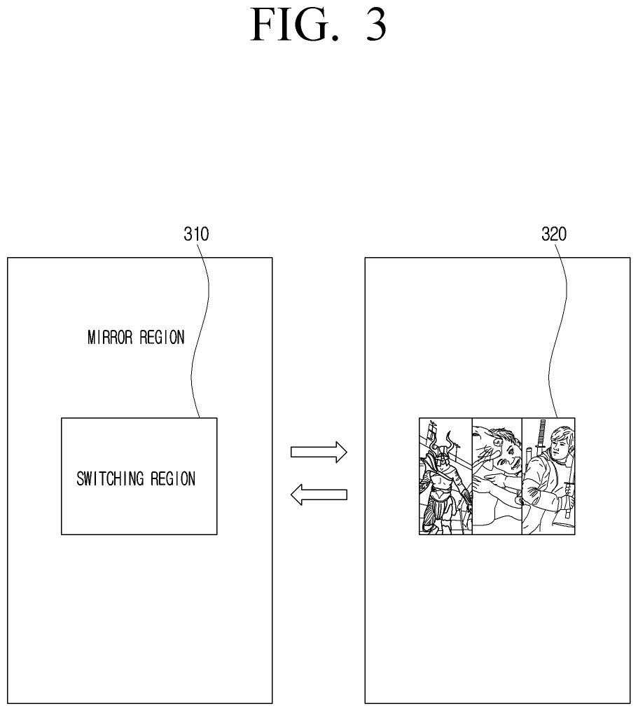

Hereinafter, the operation of the electronic device 100 will be described in more detail with reference to FIGS. 3 to 14. In FIGS. 3 to 14, individual embodiments are described for convenience of description. However, individual embodiments of FIGS. 3 to 14 may be implemented in any combination.

FIG. 3 is a diagram for describing a switching region of the electronic device 100 according to an embodiment of the present disclosure.

The front surface of the electronic device 100 includes a mirror region and a switching region, and the switchable mirror 110 and the display 120 may be arranged at the rear of the switching region. Hereinafter, for convenience of description, a region where the operation state changes is described as the switching region.

As illustrated on the left side of FIG. 3, the processor 130 may control the switchable mirror 110 to operate in the mirror mode and turn off the display 120 to operate the switching region 310 as the mirror.

Alternatively, the processor 130 may turn on the display 120 to change the switching region 320 into a region that provides information, as illustrated on the right side of FIG. 3. Here, the switchable mirror 110 may be in the transparent mode or in the mirror mode. When the switchable mirror 110 is in the transparent mode, the display 120 may provide information to the user. When the switchable mirror 110 is in the mirror mode, the display 120 may operate to provide an aesthetic effect to the user.

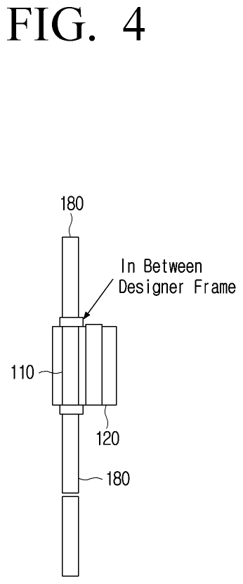

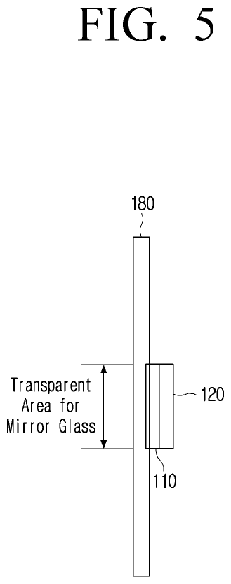

FIGS. 4 and 5 are diagrams for describing a structure of the electronic device 100 according to an embodiment of the present disclosure.

The electronic device 100 may be implemented in a form including the switchable mirror 110, the display 120 arranged so that the portion providing information is directed to one surface of the switchable mirror 110, and a mirror 180 arranged on the same plane as the switchable mirror 110, as illustrated in FIG. 4.

Alternatively, the electronic device 100 may be implemented in a form including the switchable mirror 110, the display 120 arranged so that the portion providing information is directed to one surface of the switchable mirror 110, and the mirror 180 arranged on the other surface of the switchable mirror 110, as illustrated in FIG. 5.

However, the present disclosure is not limited thereto, and the switchable mirror 110 and the mirror 180 may be implemented in various forms.

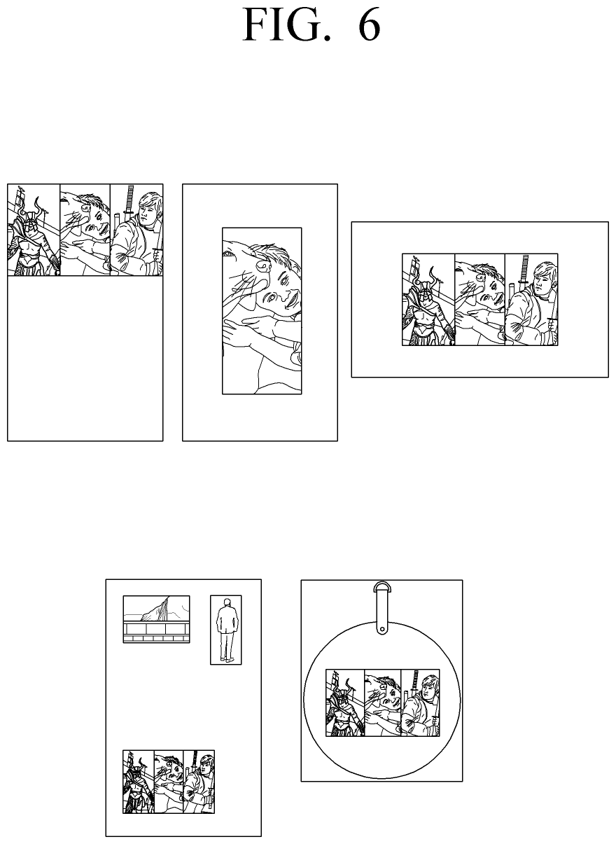

FIGS. 6 to 8 are diagrams for describing various implementation forms of the electronic device 100 according to an embodiment of the present disclosure.

The electronic device 100 may be a mirror whose length is longer than its width, as illustrated in the first upper drawing of FIG. 6, and the upper side of the mirror may be the switching region. Alternatively, the electronic device 100 may be a mirror whose length is longer than its width, as illustrated in the second upper drawing of FIG. 6, and the center of the mirror may be the switching region. Alternatively, the electronic device 100 may be a mirror whose length is longer than its width, as illustrated in the third upper drawing of FIG. 6, and the center of the mirror may be the switching region. Alternatively, the electronic device 100 may be a mirror whose length is longer than its width, as illustrated in the first lower drawing of FIG. 6, and may include a plurality of switching regions spaced apart from each other. Alternatively, the electronic device 100 may be a circular mirror, as illustrated in the second lower drawing of FIG. 6, and the center of the mirror may be the switching region.

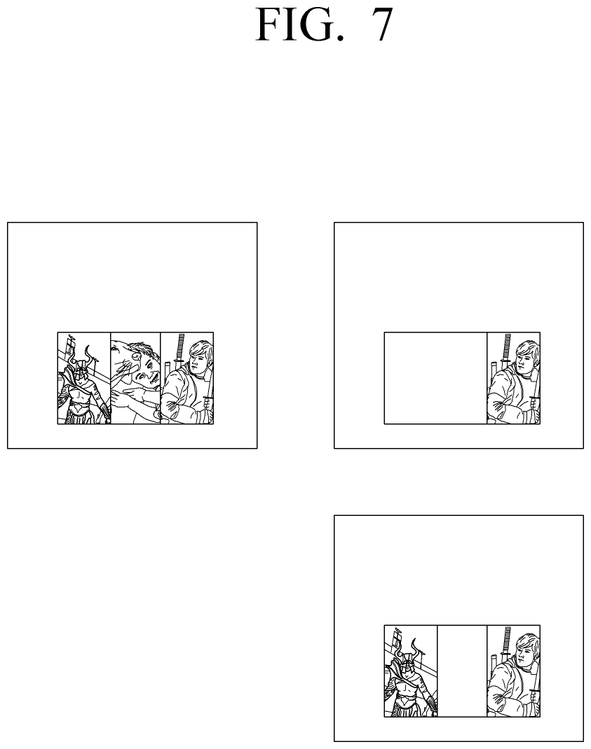

The electronic device 100 may be a rectangular mirror, as illustrated in the first upper drawing of FIG. 7, and the lower side of the mirror may be the switching region. Here, the switching region may provide information in some regions on the right side, as illustrated in the second upper drawing of FIG. 7, and the remaining regions may operate as mirrors. Alternatively, the switching region may provide information in some regions on the left side and some regions on the right side, as illustrated in the lower drawing of FIG. 7, and the remaining regions may operate as mirrors.

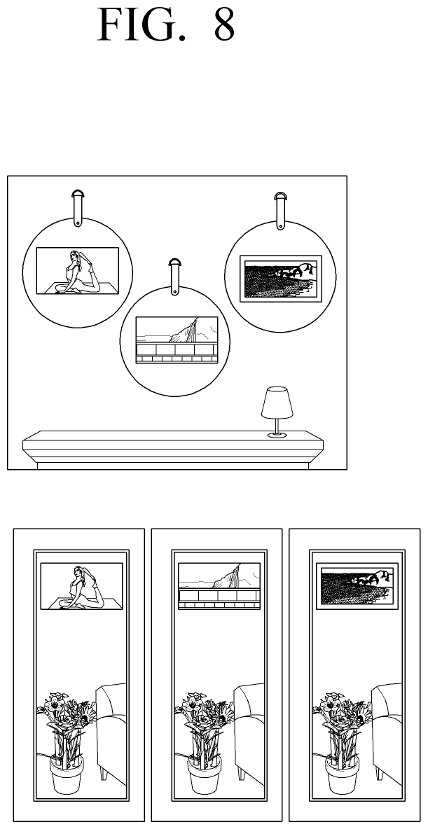

The electronic device 100 may not include the mirror 180. For example, the electronic device 100 may be implemented as a circular object including the switching region, as illustrated in the drawing of FIG. 8, or as a rectangular object including the switching region, and the object disposed on the same plane as the switching region may not be a mirror.

However, the present disclosure is not limited thereto, and the electronic device 100 may be implemented in various forms.

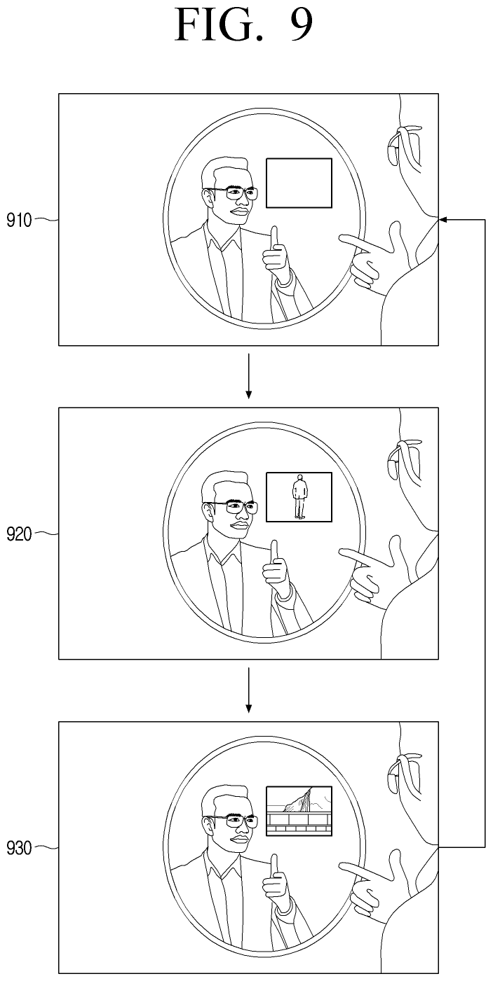

FIG. 9 is a diagram for describing an operation by user interaction according to an embodiment of the present disclosure.

The processor 130 may operate the switchable mirror 110 in the mirror mode and turn off the display 120 to operate as the mirror, as illustrated in an upper screen 910 of FIG. 9.

The processor 130 may operate in a hybrid mode by turning on the display 120 when a user touch input is received through the switching region, as illustrated in a middle screen 920 of FIG. 9.

The processor 130 may operate in the display mode by changing the switchable mirror 110 to the transparent mode when an additional user touch input is received through the switching region, as illustrated in a lower screen 930 of FIG. 9.

However, the present disclosure is not limited thereto, and the processor 130 may change the operating mode of the electronic device 100 in various ways. For example, the processor 130 may detect a user gesture and operate in a mode corresponding to the user gesture. Alternatively, the processor 130 may operate in a mode corresponding to user voice when the user voice is received. Alternatively, the processor 130 may change the operating mode of the electronic device 100 based on the type of the user touch input. For example, the processor 130 may change the operating mode of the electronic device 100 to the first mode when the user touches one point, change the operating mode of the electronic device 100 to the second mode when the user touches two points, and change the operating mode of the electronic device 100 to the third mode when the user touches three points. Alternatively, the processor 130 may change the operating mode of the electronic device 100 based on a preset sound. For example, when the processor 130 receives the sound of user's clapping, the processor 130 may change the operating mode of the electronic device 100 to the third mode.

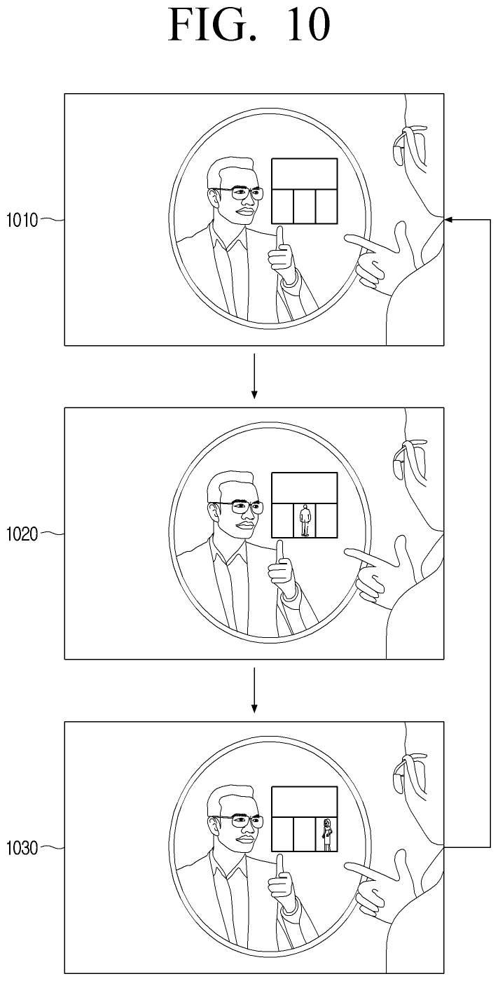

FIG. 10 is a diagram for describing the operation by the user interaction according to an embodiment of the present disclosure.

As illustrated in an upper screen 1010 of FIG. 10, the processor 130 may divide the switching region into the plurality of regions and operate the plurality of regions as the mirrors. In this case, the processor 130 may identify the switchable mirror 110 by dividing the switchable mirror 110 into the plurality of first regions, identify the display 120 into the plurality of second regions corresponding to each of the plurality of first regions, and operate the corresponding regions in conjunction with each other.

As illustrated in a middle screen 1020 and a lower screen 1030 of FIG. 10, when the user touch input is received through the switching region, the processor 130 may change the operating mode of the region where the touch input is received. For example, when the processor 130 touches the first region among four divided switching regions, the processor 130 may change the operating mode of the first region to the first mode or the second mode.

The processor 130 may also change the operating mode of the region where the user's touch input has been received based on the user's touch input and the operating status of the region where the user's touch input has been received among the plurality of regions. For example, the user may touch the second region among the four divided switching regions. In this case, the processor 130 may change the operating mode of the second region to the third mode when it is in the first mode or the second mode, and may change the operating mode of the second region to the first mode or the second mode when it is in the third mode.

The processor 130 may change the region division method of the switching region when a preset user command is received. For example, when the preset user command is received, the processor 130 may divide the switching region, which is divided into four, into three. Alternatively, when the preset user command is received, the processor 130 may change the form of the switching region divided into four. In this case, the switching region is still divided into four, but the size of each region may change.

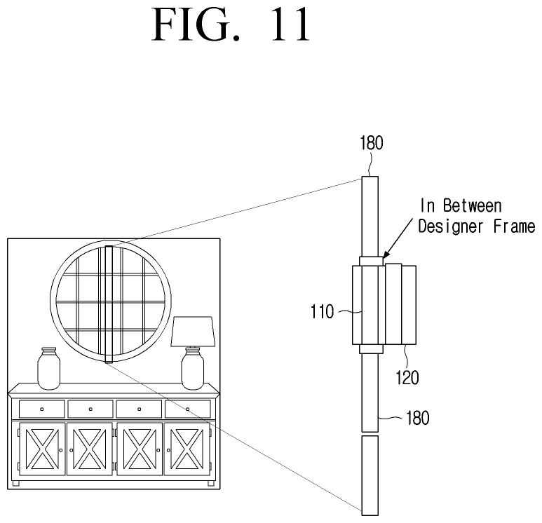

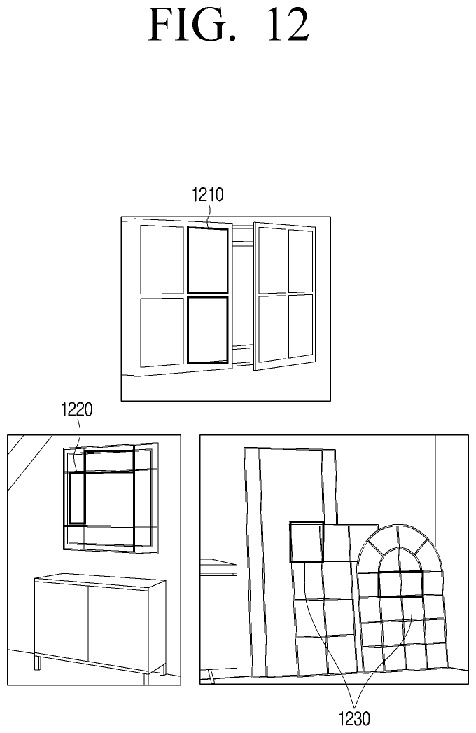

FIGS. 11 and 12 are diagrams for describing specific implementation examples of the switching region according to an embodiment of the present disclosure.

Recently released mirrors may be implemented in a form that includes a grid for the purpose of aesthetic effects, etc., as illustrated on the left side of FIG. 11. In this case, the electronic device 100 may be arranged instead of a mirror in some regions among the regions divided into grids. In this case, as illustrated on the right side of FIG. 11, the display 120 may be arranged so that the portion providing information is directed to one surface of the switchable mirror 110, and the mirror 180 may be arranged on the same plane as the switchable mirror 110.

In addition, as illustrated in FIG. 12, the electronic device 100 may be arranged at a position 1210, a position 1220, or a position 1230.

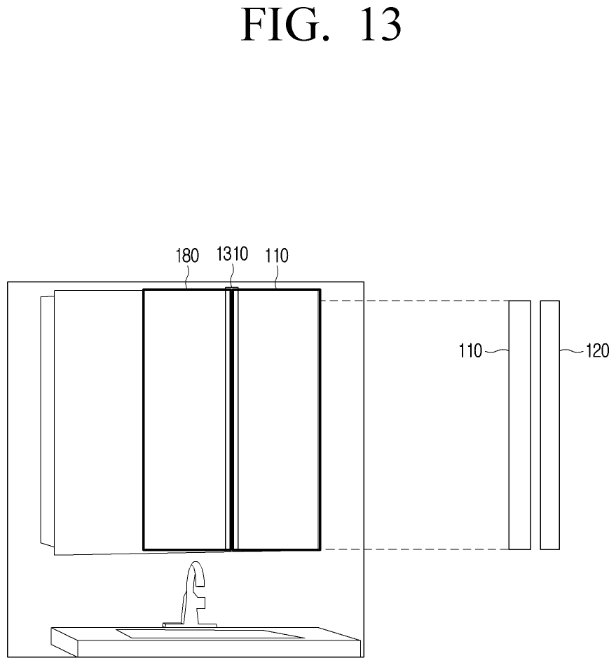

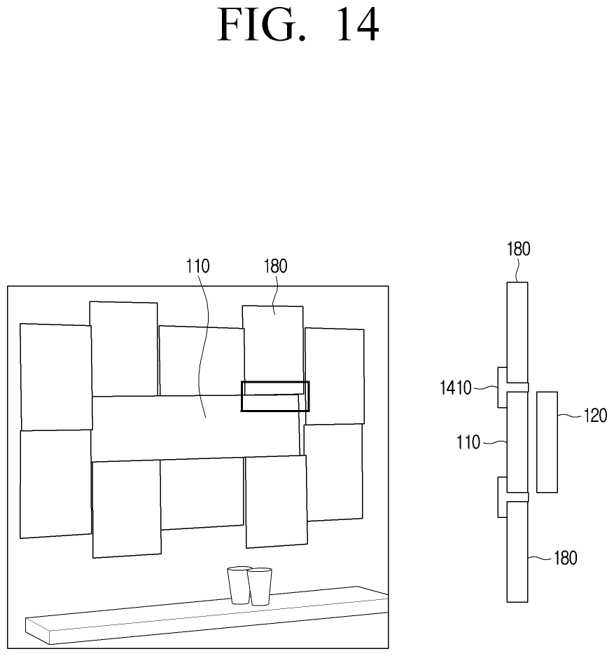

FIGS. 13 and 14 are diagrams for describing a method of connecting a switchable mirror 110 and a mirror 180 according to an embodiment of the present disclosure.

As illustrated in FIG. 13, an air gap 1310 may be formed between the switchable mirror 110 and the mirror 180. In this case, the continuity of the mirror is maintained, which may be useful when a large mirror is required.

Alternatively, as illustrated in FIG. 14, a gap filler 1410 may be arranged between the switchable mirror 110 and the mirror 180. In this case, the switchable mirror 110 and the mirror 180 may be more strongly connected, thereby increasing durability.

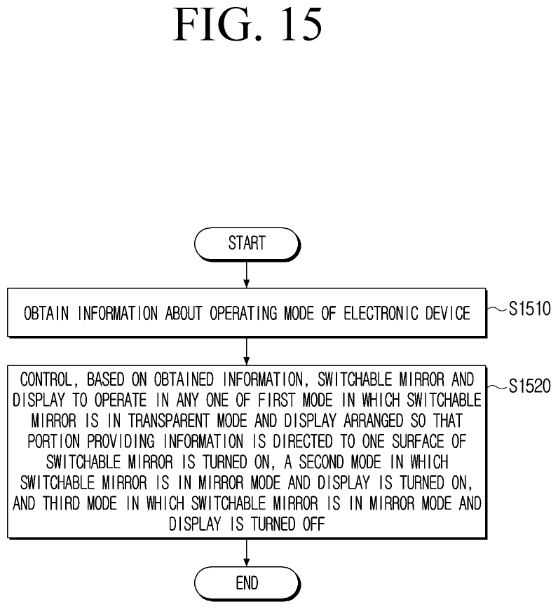

FIG. 15 is a flowchart for describing a control method of an electronic device according to an embodiment of the present disclosure.

First, the information about the operating mode of the electronic device is acquired (S1510). The switchable mirror and the display are controlled, based on the obtained information, to operate in any one of the first mode in which the switchable mirror is in the transparent mode and the display arranged so that the portion providing information is directed to one surface of the switchable mirror is turned on, the second mode in which the switchable mirror is in the mirror mode and the display is turned on, and the third mode in which the switchable mirror is in the mirror mode and the display is turned off (S1520).

In addition, the control method further includes identifying the user through the sensor of the electronic device, in which in the controlling step (S1520), the operating mode of the electronic device may change to one of the first mode and the second mode based on the user.

In addition, the control method further includes acquiring the detection data for the external light around the electronic device through the sensor of the electronic device, in which, in the controlling step (S1520), the operating mode of the electronic device may change to one of the first mode, the second mode, and the third mode based on the detection data.

The control method may further include receiving content, in which, in the controlling step (S1520), the operating mode of the electronic device may change to one of the first mode and the second mode based on the type of the content.

The control method may further include receiving the user command from the user, in which, in the controlling step (S1520), the operating mode of the electronic device may change to one of the first mode, the second mode, and the third mode based on the user command.

In addition, the control method further includes identifying the switchable mirror by dividing the switchable mirror into the plurality of first regions, in which, the controlling step (S1520), the switchable mirror may be controlled to operate each of the plurality of first regions in one of the first mode, the second mode, and the third mode.

In addition, the control method further includes identifying the display into the plurality of second regions corresponding to each of the plurality of first regions, in which, in the controlling step (S1520), the display may be controlled to turn on the second region corresponding to the region operating in the first mode or the second mode among the plurality of first regions.

In addition, the control method further includes obtaining the captured image of the user in front of the electronic device through the camera of the electronic device and identifying the user from the captured image, in which, in the controlling step (S1520), the switchable mirror may be controlled to operate the switchable mirror in one region when the user is the first user, and to operate the switchable mirror in the plurality of first regions when the user is the second user.

The switchable mirror operates in the transparent mode when the voltage is applied, and in the mirror mode when the voltage is not applied, the transparent mode may be a mode in which the transmittance of the switchable mirror is equal to or greater than the preset first transmittance and the reflectance of the switchable mirror is less than the preset first reflectance, and the mirror mode may be a mode in which the transmittance is less than the preset second transmittance and the reflectance is equal to or greater than the preset second reflectance.

According to various embodiments of the present disclosure as described above, the electronic device may operate in the multiple modes, thereby providing various interactions and aesthetic satisfaction to the user.

In addition, the electronic device may divide the switchable mirror and display into the plurality of regions and operate the plurality of regions in individual modes, thereby improving the user convenience.

Meanwhile, according to an embodiment of the disclosure, the diverse embodiments described above may be implemented as software including instructions stored in a machine-readable storage medium (e.g., a computer-readable storage medium). A machine may be a device that invokes the stored instruction from the storage medium and may be operated according to the invoked instruction, and may include the electronic device (e.g., the electronic device A) according to the disclosed embodiments. When the instruction is executed by a processor, the processor may perform the function corresponding to the instruction directly or by using other components under the control of the processor. The command may include codes created or executed by a compiler or an interpreter. The machine-readable storage medium may be provided in a form of a non-transitory storage medium. Here, the term ‘non-transitory’ means that the storage medium is tangible without including a signal, and does not distinguish whether data are semi-permanently or temporarily stored in the storage medium.

In addition, according to an embodiment of the disclosure, the methods according to the diverse embodiments described above may be included and provided in a computer program product. The computer program product may be traded as a product between a seller and a purchaser. The computer program product may be distributed in the form of a storage medium (e.g., a compact disc read only memory (CD-ROM)) that may be read by the machine or online through an application store (e.g., PlayStore™). In a case of the online distribution, at least portions of the computer program product may be at least temporarily stored in a storage medium such as a memory of a manufacturer server, an application store server, or a relay server or be temporarily created.

In addition, according to an embodiment of the disclosure, the diverse embodiments described above may be implemented in a computer or a computer-readable recording medium using software, hardware, or a combination of software and hardware. In some cases, embodiments described in the disclosure may be implemented as a processor itself. According to a software implementation, embodiments such as procedures and functions described in the specification may be implemented as separate software. Each software may perform one or more functions and operations described in the disclosure.

Meanwhile, computer instructions for performing processing operations of the machines according to the diverse embodiment of the disclosure described above may be stored in a non-transitory computer-readable medium. The computer instructions stored in the non-transitory computer-readable medium allow a specific machine to perform the processing operations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the device. Specific examples of the non-transitory computer-readable medium may include a compact disk (CD), a digital versatile disk (DVD), a hard disk, a Blu-ray disk, a USB, a memory card, a read only memory (ROM), and the like.

In addition, each of components (e.g., modules or programs) according to the diverse embodiments described above may include a single entity or a plurality of entities, and some of the corresponding sub-components described above may be omitted or other sub-components may be further included in the diverse embodiments. Alternatively or additionally, some of the components (e.g., the modules or the programs) may be integrated into one entity, and may perform functions performed by the respective corresponding components before being integrated in the same or similar manner. Operations performed by the modules, the programs, or the other components according to various embodiments may be executed in a sequential manner, a parallel manner, an iterative manner, or a heuristic manner, at least some of the operations may be performed in a different order or omitted, or other operations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

1. An electronic device, comprising:
a switchable mirror configured to operate in a transparent mode or in a mirror mode;
a display to be arranged so that at least a portion of the display is directed to one surface of the switchable mirror; and
at least one processor configured to be connected to the switchable mirror and the display, and while the at least one processor is connected to the switchable mirror and the display, the at least one processor is configured to:
obtain information about an operating mode of the electronic device, and
control, based on the obtained information, the operating mode of the electronic device to be in any one of a first mode in which the switchable mirror is in the transparent mode and the display is turned on, a second mode in which the switchable mirror is in the mirror mode and the display is turned on, and a third mode in which the switchable mirror is in the mirror mode and the display is turned off.

2. The electronic device as claimed in claim 1, further comprising:
a sensor,
wherein the at least one processor is configured to change the operating mode of the electronic device to one of the first mode and the second mode based on a user being identified through the sensor.

3. The electronic device as claimed in claim 1, further comprising:
a sensor,
wherein the at least one processor is configured to obtain detection data for external light around the electronic device through the sensor, and
change the operating mode of the electronic device to one of the first mode, the second mode, and the third mode based on the detection data.

4. The electronic device as claimed in claim 1, further comprising:
a communication interface,
wherein the at least one processor is configured to receive content through the communication interface, and
change the operating mode of the electronic device to one of the first mode and the second mode based on a type of the content.

5. The electronic device as claimed in claim 1, further comprising:
a user interface,
wherein the at least one processor is configured to change the operating mode of the electronic device to one of the first mode, the second mode, and the third mode based on a user command received from a user through the user interface.

6. The electronic device as claimed in claim 1, wherein the at least one processor is configured to identify the switchable mirror as being divided into a plurality of regions, and
control the switchable mirror to respectively operate the plurality of regions in one of the first mode, the second mode, and the third mode.

7. The electronic device as claimed in claim 6, wherein the plurality of regions are a plurality of first regions and the at least one processor is configured to identify the display as having a plurality of second regions corresponding to the plurality of first regions, and
control the display to turn on a second region among the plurality of second regions corresponding to a first region among the plurality of first regions of the switchable mirror operating in the first mode or the second mode.

8. The electronic device as claimed in claim 6, further comprising:
a camera,
wherein the at least one processor is configured to obtain a captured image of a user in front of the electronic device through the camera,
identify the user from the captured image, and
control the switchable mirror to operate in one region based on the user being a first user, and to operate the switchable mirror in the plurality of regions based on the user being identified a second user.

9. The electronic device as claimed in claim 1, wherein the switchable mirror operates in the transparent mode based on a voltage being applied, and operates in the mirror mode based on no voltage being applied,
the transparent mode is a mode in which a transmittance of the switchable mirror is equal to or greater than a preset first transmittance and a reflectance of the switchable mirror is less than a preset first reflectance, and
the mirror mode is a mode in which the transmittance is less than a preset second transmittance and the reflectance is equal to or greater than a preset second reflectance.

10. The electronic device as claimed in claim 1, further comprising:
a mirror arranged on a plane that is same as the switchable mirror,
wherein the switchable mirror has a reflectance less than a preset difference from a reflectance of the mirror while the switchable mirror is in the mirror mode.

11. The electronic device as claimed in claim 10, further comprising:
a gap filler arranged between the switchable mirror and the mirror.

12. The electronic device as claimed in claim 1, wherein the switchable mirror operates in one of a plurality of sub-mirror modes or the transparent mode,
the at least one processor is configured to control the switchable mirror to operate in one of the plurality of sub-mirror modes or the transparent mode based on at least one of detection data for external light around the electronic device or a type of content to be displayed through the display, and
the plurality of sub-mirror modes have different transmittance and reflectance from each other.

13. A control method of an electronic device, comprising:
obtaining information about an operating mode of the electronic device; and
controlling, based on the obtained information, the operating mode of the electronic device to be in any one of a first mode in which a switchable mirror is in a transparent mode and a display arranged so that at least a portion is directed to one surface of the switchable mirror is turned on, a second mode in which the switchable mirror is in a mirror mode and the display is turned on, and a third mode in which the switchable mirror is in the mirror mode and the display is turned off.

14. The control method as claimed in claim 13, further comprising:
identifying a user through a sensor of the electronic device,
wherein, in the controlling, the operating mode of the electronic device changes to one of the first mode and the second mode based on the user.

15. The control method as claimed in claim 13, further comprising:
obtaining detection data for external light around the electronic device through a sensor of the electronic device,
wherein, in the controlling, the operating mode of the electronic device changes to one of the first mode, the second mode, and the third mode based on the detection data.
